(19) United States
(12) Patent Application Publication
(10) Pub. No.: US 2020/0063821 A1
(43) Pub. Date: Feb. 27, 2020

(54) DAMPING COMPONENT WITH NON-NEWTONIAN INSERT

(71) Applicant: VIBRACOUSTIC NORTH AMERICA L.P., South Haven, MI (US)

(72) Inventors: Robert J. Ramm, Amherst, NH (US); Mickey Love, Mooresville, NC (US)

(21) Appl. No.: 16/493,576

(22) PCT Filed: Mar. 15, 2018
(86) PCT No.: PCT/US2018/022602

§ 371 Date: Sep. 12, 2019

Related U.S. Application Data
(60) Provisional application No. 62/472,627, filed on Mar. 17, 2017.

(51) Int. Cl. F16F 13/14; B60G 15/06

(52) U.S. Cl. CPC F16F 13/14; B60G 15/06; F16F 2224/0225; F16F 2226/04; B60G 2206/8101; B60G 2202/30; B60G 2206/41; B60G 2206/71; F16F 2224/02

(57) ABSTRACT

A damping component, which is suitable for vehicle applications, includes at least one body portion made of a first material, and at least one insert portion made of a second material at least partially disposed or embedded within the at least one body portion. The second material may include a non-Newtonian material.

### CROSS-REFERENCE TO RELATED APPLICATION

This application claims the benefit of U.S. Provisional Patent Application Ser. No. 62/472,627, filed on Mar. 17, 2017, the disclosure of which is hereby incorporated herein by reference in its entirety.

### TECHNICAL FIELD

The present disclosure relates to damping components with an insert, such as an insert with non-Newtonian characteristics, that may be used in various applications, including, but not limited to, jounce bumpers, body mounts, top mounts, spring isolators, and the like.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

A vehicle may incorporate various components to absorb impact and dampen noise, vibration, and harshness by preventing articulated suspension components from fully compacting during shock impacts—such as those caused by heavy loads, potholes, curbs, or objects in a roadway. Such damping components may include, but are not limited to, jounce bumpers, body mounts, top mounts, spring isolators, and the like. Inserts may be provided as part of the damping components to increase stiffness and block height of the damping components. Such inserts are typically made of a material, such as urethane, plastic, and steel, and are included with the objective of not unduly compromising damping of noise, vibration, and harshness characteristics.

There is a desire for solutions/options that minimize or eliminate one or more challenges or shortcomings of damping components. The foregoing discussion is intended only to illustrate examples of the present field and should not be taken as a disavowal of scope.

### SUMMARY

In embodiments, a damping component, for example, for a vehicle, may include at least one body portion made of a first material, and at least one insert portion made of a second material at least partially disposed or embedded within the at least one body portion. The second material may comprise a material imparting or exhibiting non-Newtonian characteristics.

In embodiments, a method of manufacturing a damping component for a vehicle may include forming at least one body portion of the damping component from a first material. The method may further include disposing or embedding at least one insert portion of the damping component made of a second material at least partially within the body portion. The second material may be a non-Newtonian material or a material exhibiting non-Newtonian characteristics.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a perspective, partial cross-sectional view of an embodiment of a body mount assembly including a non-Newtonian insert.

FIG. 2A is a top view of an embodiment of a cradle mount including a non-Newtonian insert.

FIG. 2B is a cross-sectional view of an embodiment of a cradle mount including a non-Newtonian insert.

FIG. 3A is a cross-sectional view of an embodiment of a spring aid mated with a dust boot.

FIG. 3B is a cross-sectional view of an embodiment of a spring aid including a non-Newtonian insert.

FIG. 4A is a top view of an embodiment of an upper body mount including a non-Newtonian insert.

FIG. 4B is a cross-sectional view of the upper body mount of FIG. 4A.

FIG. 5A is a top view of an embodiment of a lower body mount including a non-Newtonian insert.

FIG. 5B is a cross-sectional view of the lower body mount of FIG. 5A.

FIG. 6 is a cross-sectional view of an embodiment of a roll restrictor including a non-Newtonian insert.

FIG. 7 is a schematic flow diagram of an embodiment of a process for manufacturing an automotive damping component with a non-Newtonian insert.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

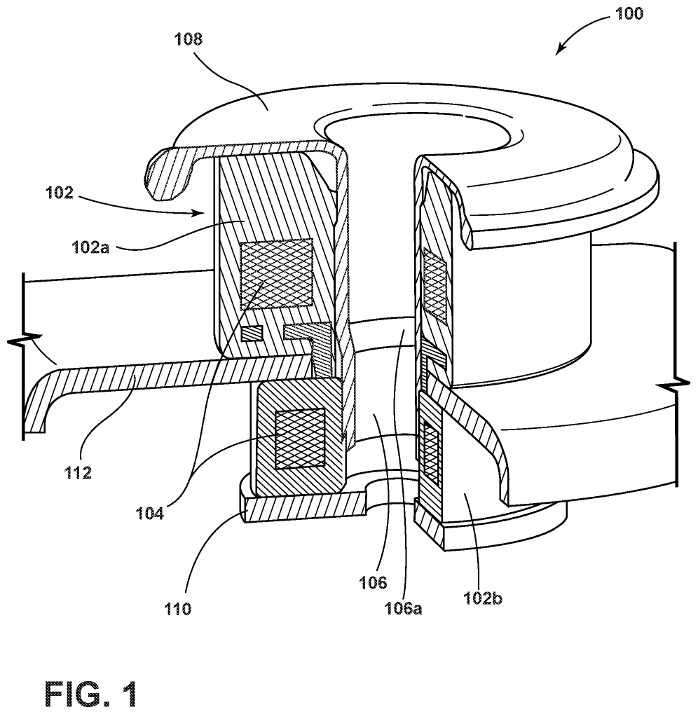

As generally illustrated in FIGS. 1 through 5B, embodiments of damping components (e.g., damping components 100, 200, 300, 400, 500, 600) may be utilized, for example, in connection with automotive applications, and may include at least one body portion (e.g., body portions 102, 202, 302, 402, 502, 602) and one or more insert portions (e.g., insert portions 104, 204, 304, 404, 504, 604) disposed or embedded within such body portion(s) (e.g., body portions 102, 202, 302, 402, 502, 602). The damping components 100, 200, 300, 400, 500, 600 may be configured to absorb shock impacts and/or dampen noise, vibration, and/or harshness, such as that experienced by a vehicle in which the damping components may be employed. It is noted that while certain figures may depict some exemplary dimensions, such dimensions are for illustrative purposes, and while embodiments may involve such dimensions, the instant disclosure is not limited to such dimensions.

With embodiments, an insert portion (e.g., insert portions 104, 204, 304, 404, 504, 604) may include one or more of a variety of shapes, sizes, configurations, and/or materials. For example and without limitation, an insert portion may include a generally annular configuration, may include an arc-shaped configuration, may include a complete annular configuration, may include a rectangular configuration, may include a single section/piece, may include a plurality of sections/pieces, and/or may include a combination of sections/pieces and a complete annular portion, among other configurations. While some configurations of body portions (e.g., body portions 102, 202, 302, 402, 502, 602) may be illustrated in connection with a particular configuration of insert portion or insert portions, it should be understood that mixing and matching of configurations of body portion with various configurations of insert portions is specifically contemplated.

In embodiments, such as generally illustrated in FIG. 1, a damping component 100 may comprise a body mount assembly.

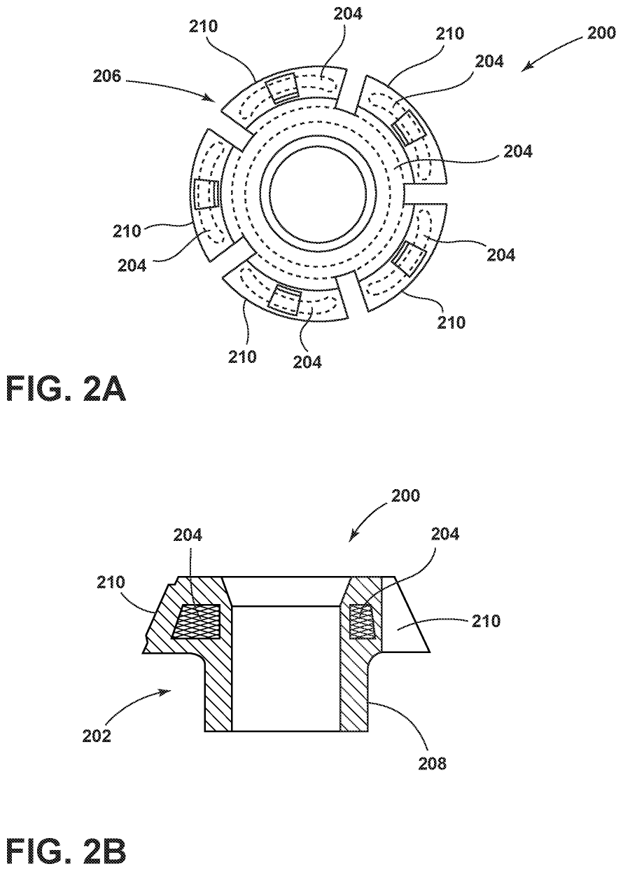

In other embodiments, such as generally illustrated in FIGS. 2A and 2B, a damping component 200 may comprise a cradle mount.

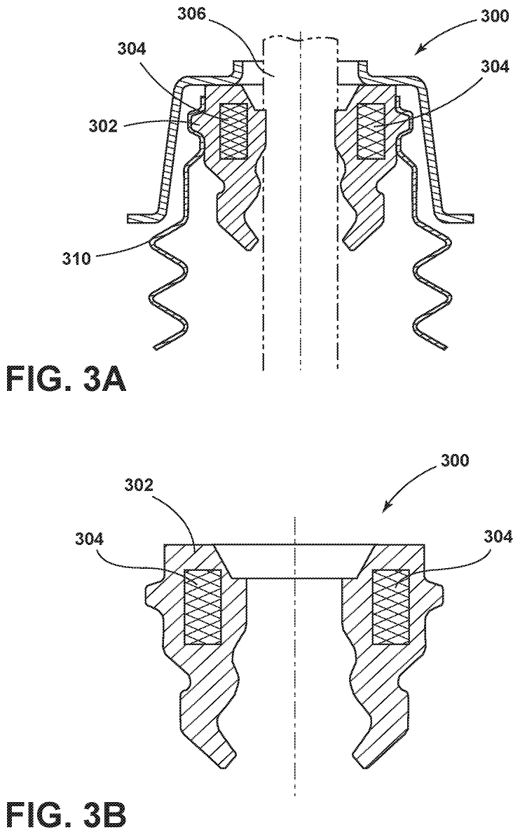

In yet other embodiments, such as generally illustrated in FIGS. 3A and 3B, a damping component 300 may comprise a spring aid.

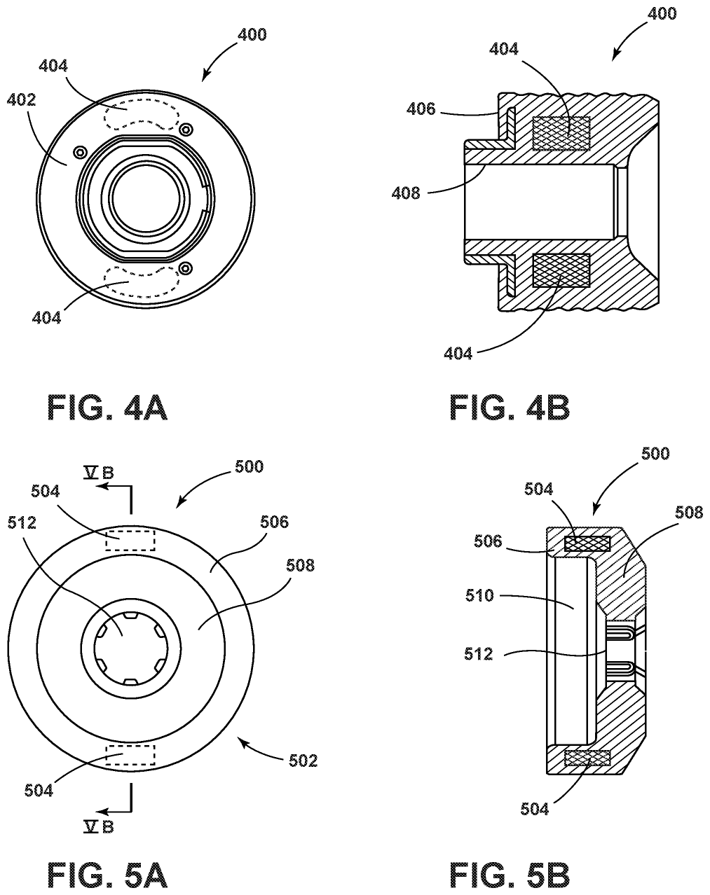

In further embodiments, such as generally illustrated in FIGS. 4A and 4B, a damping component 400 may comprise an upper body mount.

In yet further embodiments, such as generally illustrated in FIGS. 5A and 5B, a damping component 500 may comprise a lower body mount.

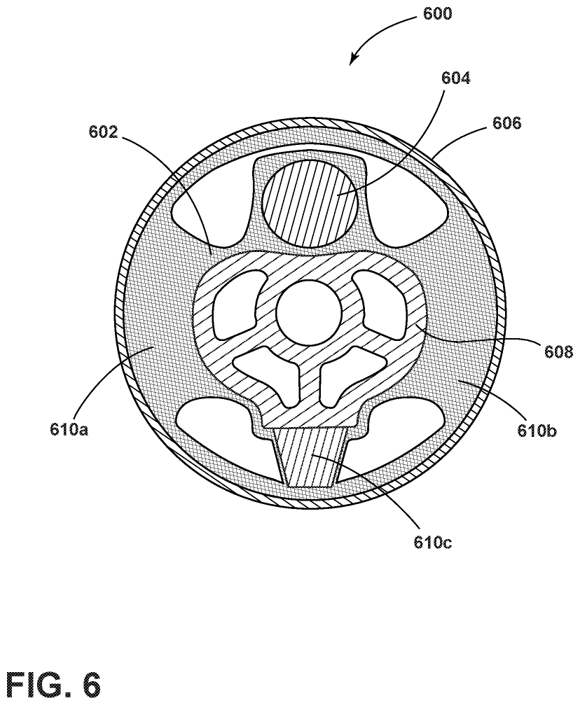

In further embodiments, such as generally illustrated in FIG. 6, a damping component 600 may comprise a roll restrictor.

It should be appreciated that various other damping components, including automotive damping components, are contemplated, and include, but are not limited to, coil spring isolators and air spring isolator pads.

In embodiments, a body portion (e.g., body portions 102, 202, 302, 402, 502, 602) may be made or comprised of a first material, and an insert portion (e.g., insert portions 104, 204, 304, 404, 504, 604) may be made or comprised of a second material that may be different than the first material.

In embodiments, the first material may be compressible, for example, up to 80% of an uncompressed state, and may be capable of reversion (or substantial reversion) to an uncompressed state of the material. Additionally or alternatively, the first material may be characterized by a relatively low weight, progressive stiffness, and/or ability to be subjected to different temperature and moisture conditions. For example, the first material may comprise, but is not limited to, microcellular polyurethane.

In embodiments, a second material may have dynamic properties, including, but not limited to, spring rate, stiffness, elasticity, viscosity, and the like, that may change as a function of a magnitude of force and/or velocity of an application or impact on the damping component (e.g., damping components 100, 200, 300, 400, 500, 600). In embodiments, the second material may exhibit non-linear stiffness in response to a strain rate. For example and without limitation, the second material may be flexible and compressible during comparatively lesser loads, such as a vehicle occupant entering or exiting a vehicle and/or engine vibrations. However, in response to an increased strain, for example, from larger impacts such as those resulting from potholes, the second material may stiffen and have reduced or negligible compressibility. In embodiments, the second material may comprise a fluid, a gel, or a gel-like solid, and may include polymers, such as silicone based polymers, which may be formed using siloxane or poly-vinyl alcohol, lubricant materials such as oil, waxes, or grease, and/or combinations thereof. For example, the second material may comprise, but is not limited to, a non-Newtonian material, such as a material that exhibits non-linear stiffness in response to a strain rate. As used herein, the term “non-Newtonian insert” may refer to an insert that is comprised of a non-Newtonian material or that demonstrates non-Newtonian characteristics, such as impact performance.

With embodiments, a body portion (e.g., body portions 102, 202, 302, 402, 502, 602) may be made or comprised of a second material, and an insert portion (e.g., insert portions 104, 204, 304, 404, 504, 604) may be made or comprised of a first material. For example and without limitation, a body portion (e.g., body portions 102, 202, 302, 402, 502, 602) may be made or comprised of a non-Newtonian material and an insert portion (e.g., insert portions 104, 204, 304, 404, 504, 604) may be made or comprised of an elastomer (e.g., an elastomer insert may be disposed/embedded in a non-Newtonian body portion).

With respect to the embodiment generally illustrated in FIG. 1, a body portion 102 of a damping component 100 (also referred to as body mount assembly 100), may include a first body portion 102a and a second body portion 102b, each having an insert portion 104 therein. While FIG. 1 illustrates two body portions 102a, 102b, it should be appreciated that there may be just one body portion or may be additional body portions. It should further be appreciated that not all of the body portions 102a, 102b may have an insert portion 104, and/or at least one of the body portions 102a, 102b may include more than one insert portion 104, each having similar or different shapes and/or configurations. With embodiments, the body portions 102a, 102b may be partially or entirely separate/discrete components.

In embodiments, body portions 102a, 102b may be annularly-shaped with inner and outer diameters and may be arranged adjacent each other or in a stacked configuration in an axial direction such that they define a channel 106 (e.g., a cylindrical inner channel). It should be appreciated that body portions 102a, 102b may have different shapes and/or configurations, including, but not limited to, spherical, semi-spherical, ellipsoidal, cuboidal, conical, and the like. As generally illustrated in FIG. 1, the inner diameters may be different such that the channel 106 has a step or transition 106a, and the outer diameters may also be different. However, it should be appreciated that the inner diameters and/or the outer diameters may be the same. In embodiments, the insert portions 102 may extend completely or only partially around the channel 106. With embodiments, the body mount assembly 100 may also have an upper end cap 108, a lower end cap 110, and an intermediate plate 112 between the body portions 102a, 102b. The end cap 108 may extend at least partially into the channel 106.

As generally illustrated in the embodiments in FIGS. 2A and 2B, a body portion 202 of another damping component 200 (also referred to as cradle mount 200) may include a flange portion 206 and a wall portion 208. In embodiments, the wall portion 208 may be annularly shaped, and the flange portion 206 may include multiple flange sections 210 that extend radially outward from the wall portion 208. While FIG. 2A illustrates five flange sections 210, it should be appreciated that there may be various numbers of flange sections, including a single flange completely or partially extending circumferentially around the wall portion 208. One or more of the flange sections 210 may have an insert portion 204 disposed or embedded therein. For example and without limitation, an insert portion 204 may be disposed in each of the flange sections 210 (e.g., five insert portions 204 each disposed and/or embedded in a respective one of five flange sections 210). An insert portion 204 may include a generally arc-shaped configuration. With embodiments including a plurality of insert portions 204, the insert portions 204 may or may not include the same configuration.

As generally illustrated in the embodiments in FIGS. 3A and 3B, a damping component 300 (also referred to as spring aid 300) may be mated with a spring or coil 310 and may be employed within a vehicle. The body portion 302 of the spring aid 300 may, for example, define a channel 306, and may have a decreasing thickness in an axial direction, such that the spring aid 300 may be mated with the spring or coil or boot 310 in a region of greater thickness. In embodiments, an insert portion 304 may be mated, disposed, and/or embedded within a region of greater thickness, for example, as generally illustrated in FIG. 3B. However, it should be appreciated that the insert portion 304 may be mated, disposed, and/or embedded at various axial locations associated with the body portion 302. Further, the insert portion 304 may extend at least partially around the channel 306 in a circumferential direction.

As generally illustrated in the embodiments in FIGS. 4A and 4B, a body portion 402 of a damping component 400 (also referred to as upper body mount 400) may have a generally cylindrical wall portion 406 that may define a channel 408. It should be appreciated that the wall portion 406 may have various other shapes and/or configurations. In embodiments, a wall portion 406 may have ribs and/or a curved or wavy outer surface, and/or an insert portion 404 may be disposed or embedded within the wall portion 406 at least partially around the channel 408 in a circumferential direction.

As generally illustrated in the embodiment in FIGS. 5A and 5B, a body portion 502 of a damping component 500 (also referred to as lower body mount 500) may have a cup shape with an annular wall portion 506 and a base portion 508 defining a cavity 510. It should be appreciated that the wall portion 506 may have various other shapes and/or configurations. The base portion 508 may define an opening 512 configured to receive, for example, a fastener. In embodiments, the insert portion 504 may be disposed and/or embedded within the wall portion 506, for example as generally illustrated in FIG. 5B, and may extend at least partially around the cavity 510 in a circumferential direction. However, it should be appreciated that an insert portion 504 may be, additionally or alternatively, disposed or embedded within the base portion 508.

In embodiments, such as generally illustrated in FIG. 6, a damping component 600 may include a body portion 602 and an insert portion 604. The insert portion 604 may be disposed or embedded partially or entirely in the body portion 602. The body portion 602 may connect an outer wall 606 of the damping component 600 to an inner portion 608 of the damping component 600. The outer wall 606 may, for example and without limitation, be configured for connection with a first external component (e.g., a first vehicle component) and/or the inner portion 608 may be configured for connection with a second external component (e.g., a second vehicle component).

With embodiments, a body portion 602 may include one or more radially-extending supports (e.g., supports 610a, 610b, 610c) that may extend from the outer wall 606 to the inner portion 608. A radially-extending support may include one or more of a variety of shapes, sizes, configurations, and/or materials. For example and without limitation, first and second radially-extending supports 610a, 610b may include the same material as the body portion 602 (e.g., an elastomer) and/or a third radially-extending support 610c may include a non-Newtonian material. Relative to a support comprising an elastomer, a non-Newtonian support may allow for additional movement of the inner portion 608 relative to the outer wall 606, which may allow for a smaller overall size of the damping component 600. For example and without limitation, an elastomer support that allows for similar movement as a non-Newtonian support may be significantly larger/taller, which may result in a larger overall size of the damping component and/or may reduce durability. A non-Newtonian support may be configured to manage a higher load in the same volume of material compared to typical elastomers, and may be more durable in the same space. A non-Newtonian support may be configured to provide a progressive increase of force resistance as speed increases. With relatively low speeds of impact, a non-Newtonian support may remain soft, and the load bearing features/characteristics of a non-Newtonian support may increase as the speed of impact increases.

With continued reference to FIG. 6, a damping component 600 may be configured to damp and/or restrict movement of an inner portion 608 in one or more directions. For example and without limitation, a damping component 600 may be configured to restrict upward and downward movement of the inner portion 608. The non-Newtonian support 610c may restrict upward and downward movement, such as at higher loads, while the other supports 610a, 610b may provide relatively little resistance to such movement.

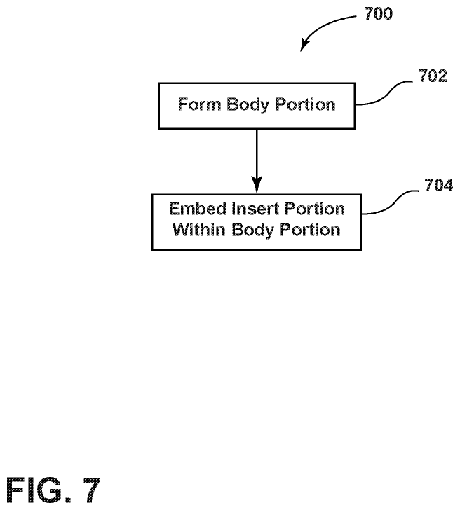

Referring to FIG. 7, an embodiment of a method 700 of manufacturing a damping component for a vehicle—including, but not limited to, a body mount assembly 100, a cradle mount 200, a spring aid 300, an upper body mount 400, a lower body mount 500, a damping component 600, and the like—is generally represented. Method 700 may begin at step 702 in which a body portion (e.g., body portions 102, 202, 302, 402, 502, 602) is formed. In embodiments, step 702 may be performed, for example, via a forming or casting process in which a liquid material is poured or provided into a mold having a cavity in a shape associated with a body portion. It should be appreciated that various processes capable of forming the body portion are contemplated. At step 704, at least a portion of at least one insert portion (e.g., insert portions 104, 204, 304, 404, 504, 604) may be disposed or embedded within the body portion (e.g., 102, 202, 302, 402, 502, 602). However, it is noted that step 704 may occur as step 702 is being performed. For example, in a forming or casting process, an insert portion may be provided in a cavity of a mold prior to the introduction of a liquid material. It should be appreciated that various other processes capable of disposing or embedding an insert portion (e.g., insert portions 104, 204, 304, 404, 504, 604) within a body portion (e.g., body portions 102, 202, 302, 402, 502, 602), for example, via injecting a liquid or moldable form of the insert portion into the body portion, for example, into pre-defined channels or cavities therein.

With regard to the processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

In some figures, portions of certain components may not be shown and/or may be hidden to more readily illustrate other elements.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

It is intended that all matter contained in the above description or shown in the accompanying drawings shall be interpreted as illustrative only and not limiting. Changes in detail or structure may be made without departing from the present disclosure.

What is claimed is:

1. A damping component for a vehicle, comprising:
at least one body portion comprised of a first material; and
at least one insert portion comprised of a second material at least partially disposed or embedded within the at least one body portion;
wherein the second material includes a non-Newtonian material.

2. The damping component of claim 1, wherein the damping component is a jounce bumper.

3. The damping component of claim 1, wherein the damping component is a cradle mount.

4. The damping component of claim 1, wherein the damping component is a spring aid.

5. The damping component of claim 1, wherein the damping component is an upper body mount.

6. The damping component of claim 1, wherein the damping component is a lower body mount.

7. The damping component of claim 1, wherein the first material comprises microcellular polyurethane.

8. The damping component of claim 1, wherein the first material is different than the second material.

9. The damping component of claim 1, wherein the at least one insert portion includes a plurality of arc-shaped insert portions.

10. The damping component of claim 1, wherein the at least one insert portion includes at least two insert portions.

11. The damping component of claim 1, wherein the at least one body portion includes a first body portion and a second body portion; the at least one insert portion includes a first insert portion and a second insert portion; the first insert portion is disposed in the first body portion; and the second insert portion is disposed in the second body portion.

12. The damping component of claim 1, wherein the at least one body portion defines a channel.

13. The damping component of claim 12, wherein an insert portion of the at least one insert portion extends completely around the channel.

14. The damping component of claim 1, wherein the at least one body portion includes a cylindrical wall defining a channel.

15. The damping component of claim 1, wherein the at least one body portion includes a region of increased thickness and the at least one insert portion is disposed in the region of increased thickness.

16. The damping component of claim 1, wherein the at least one body portion includes a plurality of flange sections.

17. The damping component of claim 1, including a spring or coil.

18. A method of manufacturing a damping component for a vehicle, comprising:
forming at least one body portion of the damping component from a first material; and
disposing or embedding at least one insert portion comprised of a second material at least partially within the at least one body portion;
wherein the second material includes a non-Newtonian material.

19. The method of claim 18, wherein forming the at least one body portion and disposing or embedding the at least one insert portion includes:
providing a mold with a cavity in a shape of at least a portion of the at least one body portion;
placing the at least one insert portion in the cavity;
providing a liquid or moldable form of the first material into the cavity at least partially around the at least one insert portion; and
forming the first material such that the at least one insert portion is at least partially disposed or embedded within the first material.

20. The method of claim 19, wherein the first material and the second material are different.
